(19) United States
(12) Patent Application Publication
(10) Pub. No.: US 2011/0142534 A1
(43) Pub. Date: Jun. 16, 2011

(54) METHOD FOR MANUFACTURING A JOINT AND A JOINT OBTAINABLE BY THE METHOD

(75) Inventors: Torgny Brogårdh, Vasteras (SE); Ove Kullborg, Vasteras (SE); Ove Ode, Vasteras (SE)

(73) Assignee: ABB TECHNOLOGY AB, Sweden (SE)

(21) Appl. No.: 12/996,172

(22) PCT Filed: Jun. 3, 2009
(86) PCT No.: PCT/EP2009/056767

§ 371 Date: Feb. 24, 2011

Related U.S. Application Data
(60) Provisional application No. 61/129,079, filed on Jun. 3, 2008.

(51) Int. Cl. F16C 11/06; B23P 25/00

(52) U.S. Cl. 403/141; 29/459; 901/28

(57) ABSTRACT

A method for manufacturing a joint. A ball is mounted on a pin. Spherical surfaces on at least two socket parts are machined. Grinding paste is applied on the ball and/or on the surfaces of the socket parts. The pin is connected to an equipment that rotates the ball. The ball is assembled between the socket parts. A pressure is applied between the socket parts and the ball. The ball is rotated and tilted over the working range of the joint. The ball and the socket parts are cleaned from the grinding paste. The joint is assembled by mounting the socket parts on a ball. A robot obtainable with the method.

### FIELD OF INVENTION

The present invention according to a first aspect thereof relates to a method for manufacturing a joint, in particular a joint for an industrial robot.

In a second aspect the invention relates to a joint obtainable by the invented method.

### BACKGROUND OF THE INVENTION

In order to transmit forces between two relative each other movable objects a link with a joint in each end is needed. One important application for this kind of transmission is parallel kinematics robots with six links, where the links transmit axial forces between actuators and a platform.

Extremely important for the performance of a parallel kinematics robot is the stiffness of the link transmissions. It is also important that the mass of the moving parts is as small as possible. The reason for this is that a robot with low inertia and high stiffness will have a high mechanical bandwidth, which is very important for high motion control performance.

Since the rods in the links of a parallel kinematics robot designed for just axial forces in the links (and no bending or twisting torques) only need to transmit axial forces these can be made very stiff and still lightweight, for example by using carbon tubes. However, using joints built up from ball- or roller bearings gives high weight relative stiffness. For example, a joint with the stiffness about 50 Newton/micron will have a weight of 0.8 kg and a joint of 400 Newton/micron will have a weight of 7 kg using high stiffness ball bearings, which means about 60 Newton/micron, kg. Having one joint in each end of a link and 6 links means in total 12 joints and it is easy to understand that it is very important to reduce the joint weight. Thus, joints with higher stiffness pro kg is very much needed since high weight of the moving parts of the robot means low natural frequencies and constraints in robot performance.

A joint of the general kind to which the present invention relates is disclosed in WO 2008/055918, which herewith is incorporated by reference.

A joint to which the present invention relates thus includes a male part and female parts, which female parts constitute the socket parts of the joint, a terminology that will be used in this application for the female parts.

### SUMMARY OF INVENTION

The object of the present invention is to provide a method for the manufacturing of a joint that results in high stiffness in relation to its weight and which has a high accuracy of the joint parts.

This object is achieved in that the method for manufacturing the joint includes the specific steps of:
A. Mounting a pin on a ball,
B. Machining spherical surfaces on at least two socket parts,
C. Applying grinding paste on the ball and/or on the surfaces of the socket parts,
D. Connecting the pin to an equipment that rotates the ball,
E. Assembling the ball between the socket parts,
F. Applying a pressure between the socket parts and the ball,
G. Rotating and tilting the ball over the working range of the joint,
H. Cleaning the ball and the socket parts from the grinding paste, and
I. Assembling the joint by mounting the socket parts on a ball.
   Thereby the shape of the female parts will be almost exactly the same as the shape of the male part, and that the surfaces of the parts will have a suitable surface finish to obtain as large surface contact area as possible meaning a large Herzian zone. In order to obtain a shape matching, at first a lathe or a corresponding machine will be used to carve out the female socket part(s). This is made to get the spherical shape and diameter of the female parts as close as possible to the male part.

A mounting pin is fixed to the spherical male part by at first machining, with a lathe or by EDH, a shallow hole in the sphere and then fix the mounting pin in this hole, for example by using laser welding, EBW or glue. In the next step of the manufacturing the mounting pin of the male part is mounted in a rotating machine and using a grinding paste, the male part is rotated and tilted in different directions when in contact with one or both the female parts. It is during this operation favourable to use grinding paste with diamonds, for example with the size of 9 micrometers.

This adaptive grinding can at first be made for each female part and then after assembling of the joint of both female parts or it can be made only with an assembled joint. In the case of an assembled joint a pre stress is obtained by a weight or a spring arrangement in an apparatus based on aerostatic electrical or hydraulic actuators.

This manufacturing method results in female parts that are very close to the shape of the male part. Due to the high accuracy of the co-operating parts, a very stiff and precise joint is achieved, and which not necessarily requires any clamping to achieve a good performance.

According to a preferred embodiment the method includes that the ball used is a ball bearing ball, which has a low cost.

The higher accuracy the spherical shape of the ball is, the higher the accuracy of the manufactured joint will have. Therefore it is particularly advantageous to use a ball bearing ball for the male part, since for such balls the preciseness of the spherical shape can be in the order of 1 micrometer or even better.

According to a further preferred embodiment, the method after step H includes the steps of
performing fine grinding or polishing, and
cleaning the ball and the socket parts.
   Thereby the surface quality is further improved. An important result of this second grinding/polishing work is that grinding material residuals from the initial grinding in step C is removed.

According to a further preferred embodiment, the method after the step mentioned next above includes applying grease on the socket parts and/or the ball.

This will further reduce the friction in the joint and contribute to a smooth operation.

According to a further preferred embodiment, step I of the method includes using shims when assembling.

Thereby a minimum of backlash can be obtained without getting the joint to get stuck.

According to a further preferred embodiment, the method after step D includes the steps of
applying a pressure between a first of the socket parts and the ball,
rotating and tilting the ball in different directions,
applying a pressure between a second socket part and the ball, and
rotating and tilting the ball in different directions.

In this way the machining of the socket parts is made individually and sequentially. Thereby the manufacturing procedure can be made simpler.

According to a further preferred embodiment, the method after the final grinding step in the embodiment mentioned above includes the further step of polishing the grinded surfaces.

This will further increase the accuracy of the surfaces of the joint parts and thus increase the Herzian zone area.

According to a further preferred embodiment, the method after the step mentioned next above includes the step of etching or blasting the polished surfaces.

According to a further preferred embodiment, when step I includes using shims, the thickness of the shims is adjusted until a certain level of friction is obtained between the ball and the socket parts.

Thereby the achievement to reduce the backlash can be balanced in an optimised way against the requirement on low friction.

For the adjustment it is advantageous to measure the friction by a torque and/or force sensor.

Preferably the sensor is mounted between the joint and a joint fixture, and the torque and/or the force is measured when the ball is rotated in one, two or three directions relative to the socket parts.

Preferably the force measurements are made between the socket parts and the joint fixture.

The measurement could in a high volume manufacturing line be accompanied by the measurement of the distance between the female parts during assembly, which is preferably performed using an interferometer measurement system.

For the interferometric measurements it is preferred that holes are made in the socket parts, through which holes the laser measurement beam is directed.

Preferably at least one hole is made in each socket part, through which a light beam can hit the surface of the opposite socket part in a gap where the shims will later be placed.

An optical interferometer is preferably used to measure the distance between the socket parts in said gap.

Preferably the measurement is made before the shims are put in place.

According to a further embodiment, the ball on which the socket part is mounted in step I is the same ball that is used for performing steps A to H.

Although a satisfactory result can be obtained by using a separate ball for finishing the socket parts and another ball as the actual joint component, the accuracy will be maximized if the same ball is used for both these functions. In that case both the ball and the female parts should be cleaned after the grinding.

The invention also relates to a method of manufacturing an industrial robot having joints, wherein at least one of the joints is manufactured according to the present invention, in particular to any of the preferred embodiments thereof.

The method for manufacturing the industrial robot is in particular advantageous for a parallel kinematics robot.

According to the second aspect of the invention, it relates to a joint obtainable with the method according to the present invention, in particular to any of the preferred embodiments thereof.

The invented joint has advantages of similar kind as those specified for the manufacture of the joint, in particular according to any of the preferred embodiments thereof, and which advantages have been described above.

According to a further preferred embodiment of the invented joint, it includes two female parts formed by two socket parts and one male part formed by a ball.

The advantages of the invention is particularly important when applied to this combination of components.

According to a further preferred embodiment at least one of the male and female parts is provided with at least one connection pin.

The number of connection pins to each part is preferably one or two.

In case the male part has two pins, these can preferably be connected to a bridge, which bridge has a connection element. The connection element might also be a pin.

The connection pins are favourable means for connecting the joint parts to the links and/or a platform of an industrial robot in which the joints are mounted, e.g. in a parallel kinematics joint.

According to a further preferred embodiment the two female parts are connected to each other by a screw joint, and preferably shims are mounted between the female parts.

The screw joint can preferably include mating screw threads on the two parts through which the parts are screwed together.

Alternatively the screw joint consists of separate screws through which the female parts are joined. The screws can preferably be located on one and the same side of the ball.

Connecting the female parts by a screw joint results in a very stiff and rigid joint. The manufacturing method of the present invention results in such a high degree of accuracy that a well functioning joint is obtained even if no biasing means are present.

By providing shims between the female parts adjusted according to the present invention, further improves the proper functioning of the joint since this makes it possible to further increase the accuracy regarding the relative position of the female parts.

According to a further preferred embodiment, each female part is ring-shaped.

The ring-shape allows a large constructional freedom how to arrange the male and female parts in relation to each other and this results in a high flexibility to adapt the joint for a particular application. By the ring-shape a relatively large contact area can be obtained while easily assuring a uniform contact pressure.

According to a further preferred embodiment, the two female parts together form a yoke with contact surfaces to the ball on opposite sides of the ball, which can be used to increase the working range of the joint.

This is an embodiment that is particularly useful when each female part is a segment of a sphere. However it can also be applied when one or both female parts are ring-shaped.

Connecting the female parts by such yoke will result in a very rigid maintenance of the relative position of the female parts by constructional simple means.

The invention also relates to an industrial robot that includes at least one joint according to the present invention, in particular to any of the preferred embodiments thereof. Preferably the industrial robot is a parallel kinematics robot.

The above preferred embodiments of the invented joint are specified in the claims depending on claim 12.

It is to be understood that further preferred embodiments of the invented method, of the invented joint and of the invented industrial robot of course can be realized by any possible combination of the preferred embodiments mentioned above, and of the further advantageous arrangements also mentioned above.

There are also many other applications for the joint, for example in measurements systems where high precision position measurements are needed. One such example are the joints in a double ball bar arrangement used for the calibration of robots and numerically controlled machines.

The invention will be further explained by the following detailed description of examples thereof and with reference to the accompanying drawings.

### BRIEF DESCRIPTION OF THE DRAWINGS

FIG. 1 is a schematic perspective view of a parallel kinematics robot according to the invention.

FIG. 2 is an axial section through a joint according to a first example of the invention.

FIG. 3 is an axial section through a joint according to a further example of the invention.

FIG. 4 illustrates a manufacturing step according to an example of the invention.

FIG. 5 is an axial section through a joint according to a still further example of the invention.

FIG. 6 is an axial section through a joint according to a still further example of the invention.

FIG. 7 illustrates another manufacturing step according to an example of the invention.

FIG. 8 is a perspective view of a detail of a joint according to a still further example of the invention.

FIG. 9 is a section in the yz-plane of the joint of FIG. 8.

FIG. 10 is a section in the xz-plane of the joint of FIG. 8.

FIG. 11 is an axial section through a joint according to a still further example of the invention.

FIG. 12 illustrates a manufacturing step according to a further example of the invention.

FIG. 13 is a perspective view of a detail of a joint according to a still further example of the invention.

FIG. 14 is a section in the yz-plane of the joint of FIG. 13.

FIG. 15 is a section in the xy-plane of the joint of FIG. 13.

FIG. 16 is a section along line XVI-XVI of FIG. 17.

FIG. 17 is an axial section through a joint according to a still further example of the invention, and also illustrates a manufacturing step.

FIGS. 18 and 19 illustrate manufacturing steps according to a still further example of the invention.

FIG. 20 is an axial section through a joint according to a still further example of the invention.

FIG. 21 is an axial section through a joint according to a still further example of the invention.

FIG. 22 illustrates a manufacturing step of the joint of FIG. 21.

### DETAILED DESCRIPTION OF EXAMPLES OF THE INVENTION

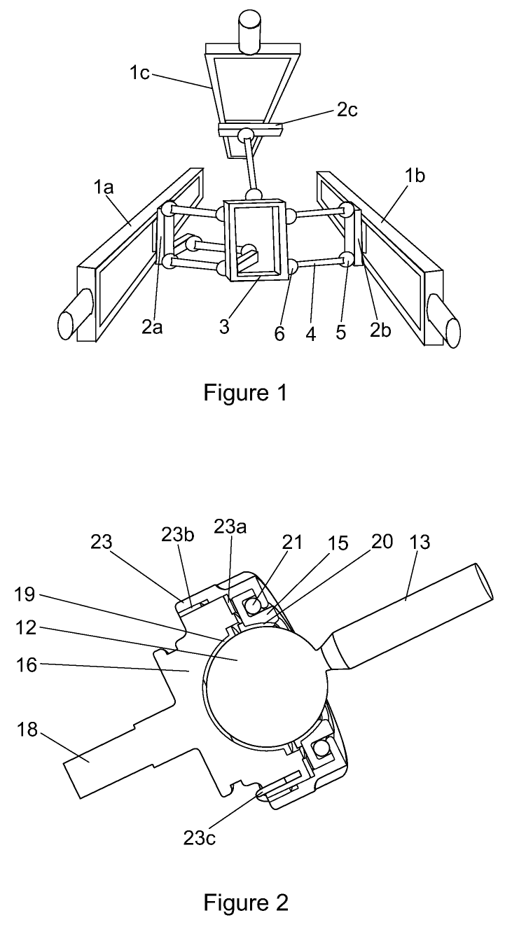

FIG. 1 schematically illustrates a parallel kinematic robot with six links, where the links transmit forces between actuators and a platform. Three linear actuators 1a, b and c move three carts 2a, b and c along three linear guide ways. The carts are connected to a platform 3 via links with joints in each end. Each link consists of a rod 4, of which one joint 5 connects it to the cart 2b and another joint 6 connects it to the platform 3. Both joints can have three degrees of freedom (DOF) in this link configuration of the parallel kinematics robot. However it will work also with two degrees of freedom for each joint even if the link assembly then will be over constrained, which can lead to the introduction of residual torques in the links. Often a design with three degrees of freedom joints at the cart side is used and with two degrees of freedom joints at the platform side.

The parallel kinematic robot schematically illustrated in FIG. 1 is an application in which the joints of the present invention are particularly suitable.

FIG. 2 shows a joint design according to an example of the invention. A spring retainer 23 is screwed on one female unit 16, whereby a pre stress force is applied on the rubber ring 21, which in turn pushes the other female unit 15 against the first female unit 16 via the spherical male unit 12. In between the male unit and the female units there are plastic layers 19 and 20. The male unit is mounted on a link or a platform/cart holder by means of the pin 13 and the left female unit 16 is mounted with the pin 18. 23a is a ring formed shims used to obtain correct force from the rubber ring. 23c is a pin used to lock the screwing of the spring retainer 23 on the female unit 16 with respect to the screwing.

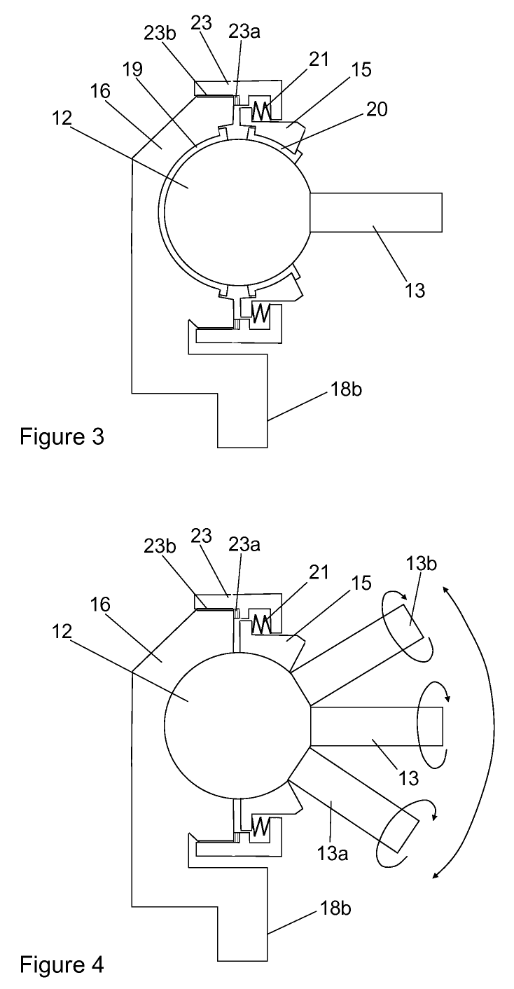

FIG. 3 shows a joint with a similar design as in FIG. 2 but here the mounting pin 18b. is mounted on the side of the left female unit 16 instead. In this way a link mounted on the pin 18b in the direction thereof will be able to rotate 360 degrees around the pin 13 of the male part. This can be used to obtain a larger work space in this DOF.

The plastic layers 19, 20 in FIG. 3 can be omitted, whereby the male part 12 will be in direct contact with the female parts 15, 16, which means a metal to metal bearing in the interfaces 19 and 20. When metal to metal bearing technique is used one of the best surface treatment is to cover the ball surface with DLC (Diamond Like Carbon), which can have a hardness of 1500 to 3000 HV and a friction coefficient as low as 0.08. Beside a hard and low friction ball surface it is also important to have a very small shape error of the ball, which is obtained for example by using bearing balls. If the female units are made by steel, for example SS2260 steel cured to 56-58 HRC, the machining of these must be made with the same low shape error as the ball. An alternative is to use a softer material that will adapt the shape accuracy of the ball, for example bearing bronze material. It should be emphasized that because of the large surfaces in the joints compared with ball- or roller bearings, the surface pressure will be low, about 3 MPa in a robot with tool forces about 1000 N.

FIG. 4 illustrates how an extremely accurate match is obtained between the spherical shape of the ball and the female parts. By rotating and tilting (13′, 13″) the pin 13 on the male part while having a grinding paste between the male part 12 and the female parts 15 and 16, the shape of the female parts will be adapted to the perfect spherical shape of the male ball 12. The joint of FIG. 4 has no plastic layers as is the case in FIG. 3. Thereby the ball 12 that forms a part of the joint can be used for the illustrated grinding operation.

In the case plastic layers are used as in FIG. 3, a ball with the same diameter as the plastic surface against the female parts is used and then in operation, a ball with a smaller diameter equal to the diameter of the plastic surfaces which are pressed towards the ball is used. It is then also possible to improve the shape and surface quality of the plastic layer by grinding with the ball of the smaller diameter.

In the case when no plastic layers are used as in FIG. 4 the grinding is either made with a ball having the same diameter as the ball that will be used in operation, or the same ball for grinding is used as for operation. Since the grinding makes the surface rough it is an advantage to make fine grinding and polishing afterwards. This is important if the same ball is used for grinding and operation if the ball needs a layer of for example Diamond Like Carbon.

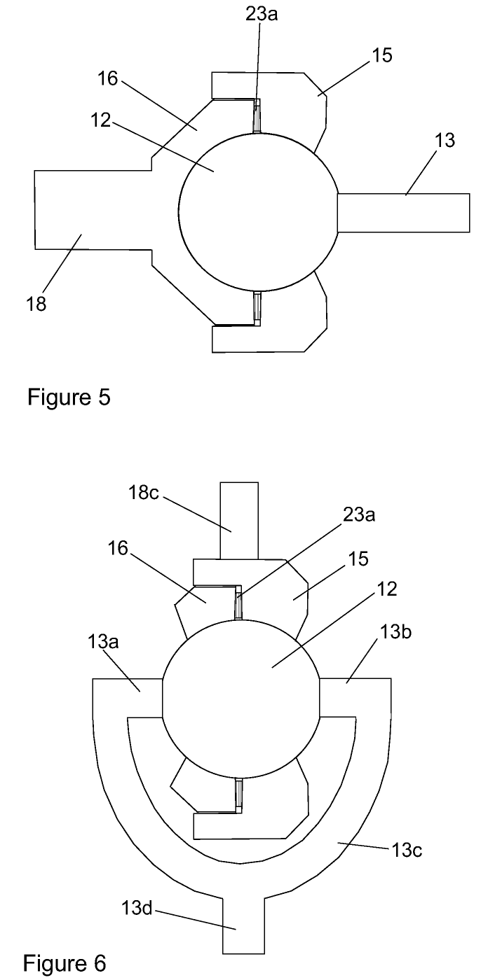

FIG. 5 shows the possibility to make a joint without spring system for compensation of joint interface wear. Using surface treatments with Diamond Like Carbon the wear will be negligible and the female parts can be mounted together directly using only the shims 23a in order to adjust the female parts in relation to the male ball. In this case it is even more important to use the joint ball to grind the female parts since the shape and dimension match must be accurate on the micrometer level. Thus, a ball can at first be used together with a grinding paste e.g. with diamonds or silicon carbide to grind the shape of one of the female parts and then of the other female part. Then the joint is mounted with a certain screwing torque without the shims 23a and the two female parts are grinded together. Of course it is also possible to grind the two female parts together from the beginning.

FIG. 6 shows a possibility to obtain a larger working range in two Degrees Of Freedom (DOF) for the joint in FIG. 5. Here both female parts 15, 16 are ring formed making it possible to have a pin (13a, 13b) mounted on each side of the ball 12. The two pins 13a and 13b are mounted on a bridge 13c, which in turn carries the pin 13d that is mounted on a link or a platform of the parallel kinematics robot. The other mounting pin 18c is mounted on the right female part 15.

Of big importance is to obtain an exact shims bundle (23a) thickness. According to the method this is obtained by testing with different shims thickness levels until the resistance (friction) of the ball to rotation and swinging movements is at a certain level. For an automated manufacturing the resistance can be measured with a force and/or torque sensor mounted between the pin 13 or 18 and a fixture or a spindle. The best solution is of course to use a sensor between the joint and a fixture for the joint. With a high accuracy machining of the female parts, the starting value for the shims thickness is almost the same for each individual joint. Only a few trials on the micrometer level are needed until the desired mobility of the ball in the female parts is obtained. For manufacturing in a larger scale the differences in the female parts in relation to reference female parts can be measured using for example a laser interferometer making it possible to directly calculate the correct shims selection.

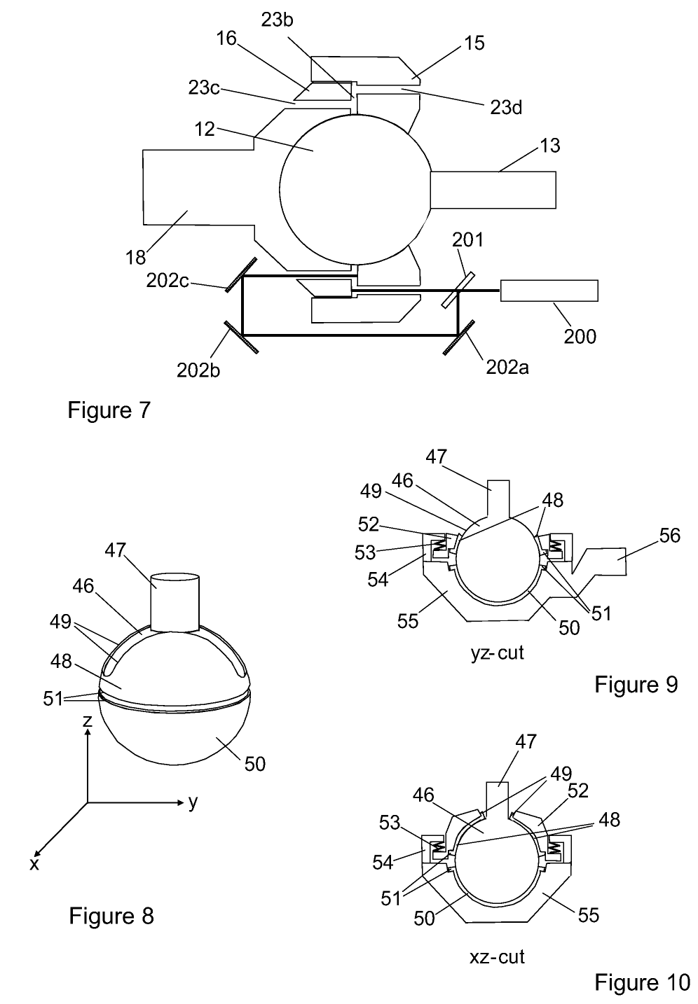

It is also possible to measure the gap directly using a laser interferometer according to FIG. 7. This is made after grinding and polishing the female parts with a male ball. Thus the female parts are screwed together with a certain torque to guarantee that the ball and the female parts are in firm contacts with each other. Through holes 23c and 23d a laser beam can obtain a reflection on the wall opposite the hole in the shims gap 23b. How such measurements can be made is exemplified for one pair of holes at the bottom of the figure.

The laser interferometer 200 measures the differences between the walls in the shims gap by sending one laser beam into two holes and mixing the laser beams in the semi transparent mirror 201. In order to obtain measurements through both the holes three mirrors 202a, b, c are used. With a perfect screw joining it is enough with one hole-pair but for high precision three hole pairs (23c and 23d) should be used, drilled with 120 degrees distance from each other.

FIG. 8 shows a joint design, where a larger interface surface is obtained between the male and female parts, which is an advantage with respect to joint stiffness. The male part 46 and its mounting pin 47 can rotate and tilt between the plastic layer parts 48 and 50. In the plastic layer 48 there is a slit 49 for the tilting of the pin 47. In FIGS. 9 and 10 the female parts 52 and 55 can be seen as well as the plastic layers 48 and 50, the spring washer 54 and the spring 53. With the mounting pins 47 and 56 in 90 degrees relative each other and a link mounted on the pin 56 it is possible to swing the link 360 degrees in the horizontal plane and about +/−60 degrees in the vertical plane. The same joint design can of course be used without having plastic layers 48 and 50.

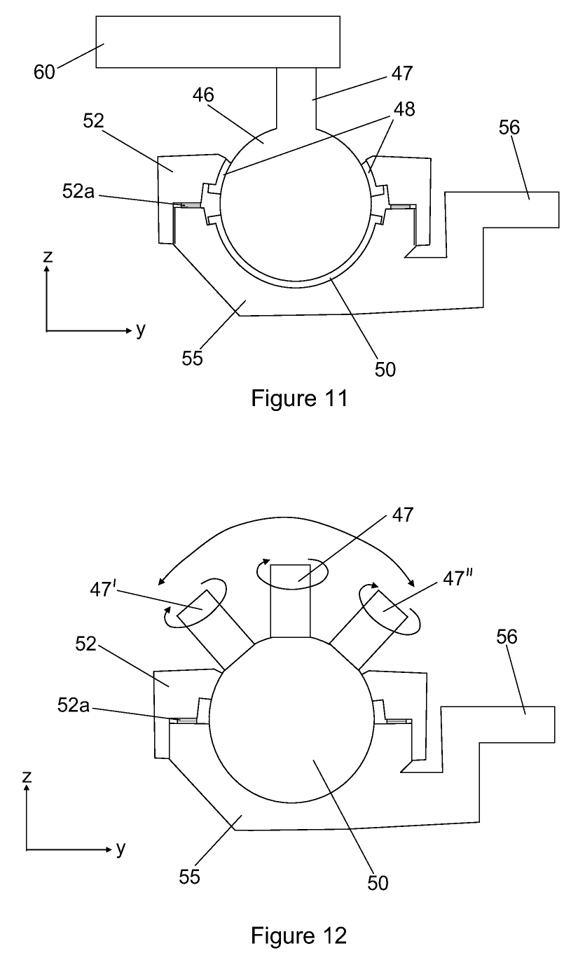

FIG. 11 shows a version for FIG. 9 without wear compensation. Here the shims 52a are adapted to obtain the pre-stress wanted between the female parts 50 and 52. The male sphere part 46 is either a manipulated platform or an actuated cart, see FIG. 1. In the FIG. 60 exemplifies an arm mounted on the joint.

FIG. 12 illustrates how a joint similar to those in FIGS. 8-11, but without plastic layer, can be ground and polished by rotating and tilting the ball 46 when the joint is assembled. In the figure the shims 52a is used but as said before this is not necessary during the grinding or polishing operation. Instead a screw torque between 52 and 55 can be used to obtain a sufficient surface pressure between the male and female parts during grinding.

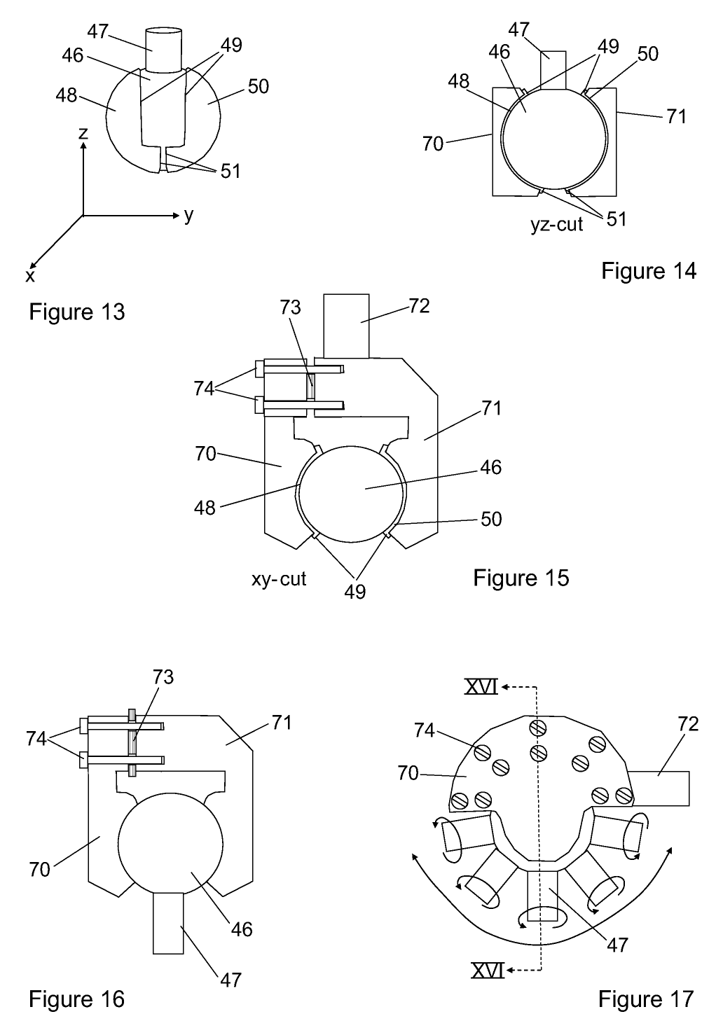

FIGS. 13-15 show a design where a large joint work space can be obtained. FIG. 13 defines the geometry of the plastic bearing halves 48 and 50 with flanges 49, and as can be seen, the pin 47 can now be tilted up to +−90 degrees. The female parts 70 and 71 are according to FIG. 15 clamped together with screws 74, and the shims 73 are used to obtain optimal pre stress and zero backlash. The mounting pin 72 should be mounted on a link and the mounting pin 47 on the manipulated platform or an actuated cart.

FIGS. 16 and 17 show a variant of the example of FIGS. 13-15. The pin 47 is mounted on a platform or an actuated cart and the pin 72 is mounted on a link. In order to obtain high stiffness several screws 74 are used to mount the left female part 70 on the right female part 71 with shims 73 in between. FIG. 17 shows the joint from the side with multiple screws 74 for high stiffness. In this figure the grinding movements are also indicated.

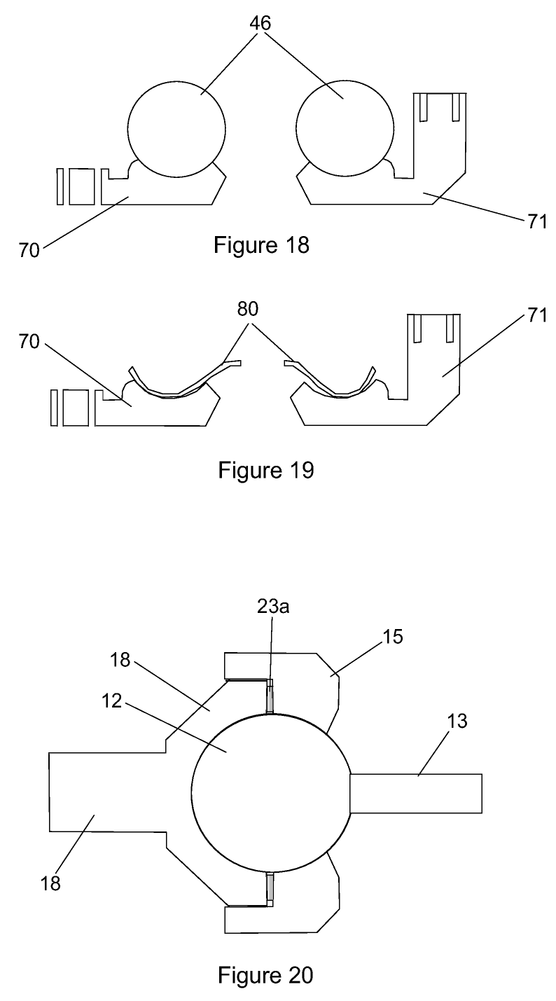

The grinding can also be performed for each female part separately using a ball 46 with the correct diameter as shown in FIG. 18. In FIG. 19 is shown how a fine grinding cloth 80 can be used to remove grinding diamonds and obtain an improved surface finish.

FIG. 20 shows a joint similar to that of FIG. 5 but where the right female part 15 has been made smaller and where it is screwed inside the left female part 16.

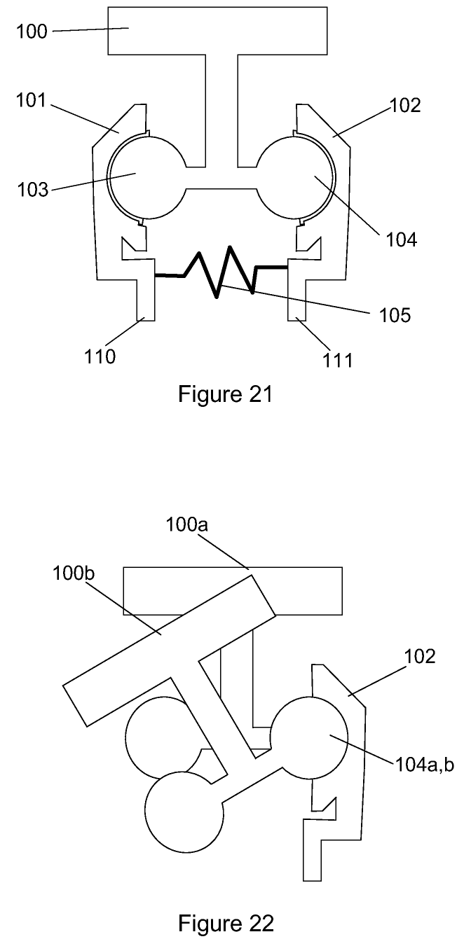

FIG. 21 shows that the adaptive grinding can also be used for a double ball joint with a spring 105 for pre stress of the female parts 101 and 102 against the male ball parts 103 and 104. 100 is part of the manipulated platform or actuated carts. Links are mounted on the pins 110 and 111. FIG. 22 illustrates how the grinding is made by rotating and tilting the male part 104 relative the female part 102. Of course the grinding is made before the balls are connected to each other.

1. A method for manufacturing a parallel a parallel kinematics robot comprising joints, the method comprising:
manufacturing at least one of the joints including
mounting a pin on a ball,
machining spherical surfaces on at least two socket parts,
applying grinding paste on at least one of the ball or the spherical surfaces of the socket parts,
connecting the pin to an equipment that rotates the ball,
assembling the ball between the socket parts,
applying a pressure between the socket parts and the ball,
rotating and tilting the ball over a working range of the joint,
cleaning the ball and the socket parts from the grinding paste,
assembling the joint by mounting the socket parts on a ball, and
connecting the joint to at least one link of the parallel kinematics robot.

2. The method according to claim 1, wherein the ball is a ball bearing ball.

3. The method according to claim 2, further comprising after cleaning the ball and socket parts:
performing fine grinding to remove grinding material residuals, and
cleaning the ball and the socket parts.

4. The method according to claim 1, further comprising:
applying grease on at least one of the socket parts or the ball after cleaning the ball and socket parts.

5. The method according to claim 3, further comprising:
applying grease on at least one of the socket parts or the ball after performing fine grinding and cleaning the ball and the socket parts.

6. The method according to claim 1, wherein assembling the joint comprises using shims when assembling.

7. The method according to claim 1, further comprising after connecting the pin to an equipment that rotates the ball:
applying a pressure between a first of the socket parts and the ball,
rotating and tilting the ball in different directions,
applying a pressure between a second socket part and the ball, and
rotating and tilting the ball in different directions.

8. The method according to claim 3, further comprising:
polishing ground surfaces after performing fine grinding and cleaning the ball and the socket parts.

9. The method according to claim 1, further comprising:
etching or blasting of the surfaces after cleaning the ball and the socket parts.

10. The method according to claim 8, wherein assembling the joint comprises adjusting the thickness of the shims until a certain level of friction is obtained between the ball and the socket parts.

11. The method according to claim 1, wherein the ball on which the socket parts are mounted is the same ball that is used when mounting a pin on a ball, machining spherical surfaces on at least two socket parts, applying grinding paste on at least one of the ball or the spherical surfaces of the socket parts, connecting the pin to an equipment that rotates the ball, assembling the ball between the socket parts, applying a pressure between the socket parts and the ball, rotating and tilting the ball over a working range of the joint, and cleaning the ball and the socket parts from the grinding paste.

12. A parallel kinematics robot, obtained with a method comprising:
manufacturing at least one of the joints by
mounting a pin on a ball,
machining spherical surfaces on at least two socket parts,
applying grinding paste on at least one of the ball or the spherical surfaces of the socket parts,
connecting the pin to an equipment that rotates the ball,
assembling the ball between the socket parts,
applying a pressure between the socket parts and the ball,
rotating and tilting the ball over a working range of the joint,
cleaning the ball and the socket parts from the grinding paste,
assembling the joint by mounting the socket parts on a ball, and
connecting the joint to at least one link of the parallel kinematics robot.

13. (canceled)

14. The robot according to claim 12, wherein the robot includes at least one joint comprising two female parts formed by two socket parts and one male part formed by a ball.

15. The robot according to claim 14, wherein the robot comprises at least one joint of which at least one connection pin is attached to at least one of the male or female parts.

16. The robot according to claim 15, wherein the two female parts are connected to each other by a screw joint, and preferably shims are mounted between the female parts.

17. The robot according to claim 16, wherein each female part is ring-shaped.

18. The robot according to claim 14, wherein the two female parts together form a yoke with contact surfaces to the ball on opposite sides of the ball.

19. (canceled)
